(19) United States
(12) Patent Application Publication
(10) Pub. No.: US 2005/0072899 A1
(43) Pub. Date: Apr. 7, 2005

(54) Inclination detector, optical head, optical information processor computer, video recorder, video reproducer, and car navigation system

(76) Inventor: Jouji Anzai, Minoh-shi Osaka (JP)

Correspondence Address: MERCHANT & GOULD PC, P.O. BOX 2903, MINNEAPOLIS, MN, 55402-0903, US

(21) Appl. No.: 10/499,804

(22) PCT Filed: May 22, 2003
(86) PCT No.: PCT/JP03/06370

(30) Foreign Application Priority Data
Jun. 6, 2002 (JP) 2002-165804

(51) Int. Cl. G02B 7/04

(52) U.S. Cl. 250/201.5

(57) ABSTRACT

Light from a light source (1) is split by an optical splitting means (2) into a main beam and at least two subbeams. A focusing optical system (6) focuses the main beam and the subbeams to the vicinity of an optical disc (7) such that their focal points are different in the direction of the optical axis of the focusing optical system (6) and the direction orthogonal thereto. A detecting means (9) detects relative inclination of the optical disc (7) to the optical axis of the focusing optical system (6) by detecting the spot size on the detecting means (9) of the subbeam reflected off the optical disc (7). Relative inclination of the optical disc (7) to the optical axis of an optical head can thereby be detected with high accuracy without increasing the size or the cost of the optical head.

### TECHNICAL FIELD

The present invention relates to a tilt detecting device for detecting the relative tilt of an optical information recording medium such as an optical disk or an optical card with respect to an optical pickup. Also, the present invention relates to an optical head including this tilt detecting device and recording, reproducing or erasing information with respect to an optical information recording medium, and an optical information processing apparatus.

Further, the present invention relates to a computer, a video recording apparatus, a video reproducing apparatus and a car navigation system including this optical information processing apparatus as a storage device.

### BACKGROUND ART

In recent years, accompanying the development of optical disks, various optical disks such as recording/reproducing optical disks and read-only memory (ROM) optical disks have come into use. Under such circumstances, many systems have been devised for detecting the relative tilt of an optical disk with respect to an optical head caused by a warp or the like of the optical disk, which is one of the causes of spot quality deterioration on the optical disk.

FIG. 6 shows a configuration of a conventional optical head on which a device for detecting the relative tilt of an optical disk to the optical head is mounted. In FIG. 6, a laser beam emitted from a semiconductor laser 101 is reflected by a prism 103, turned into a parallel beam by a collimator lens 104, focused by an objective lens 105 and forms a spot on an information recording surface of an optical disk 106. Then, a light beam reflected by the optical disk 106 passes through the objective lens 105 again, passes through the collimator lens 104, the prism 103 and a cylindrical lens 108 and then enters a photo-detector 109. Conventionally, a tilt sensor 110 for detecting the relative tilt of the optical disk 106 to the optical head caused by a warp or the like of the optical disk 106 has been provided on a top surface of a head base 111. This tilt sensor 110 includes a light-emitting diode 112 and light-receiving elements 113 and 114 disposed so as to sandwich the light-emitting diode 112. Light emitted from the light-emitting diode 112 is reflected by the optical disk 106 and then received by the light-receiving elements 113 and 114. The relative tilt is detected by the difference in outputs of these light-receiving elements 113 and 114.

As described above, in a conventional optical pickup, the tilt sensor 110 for detecting the relative tilt of the optical disk to the optical pickup has been provided on the head base 111 of the optical pickup, leading to an increase in the size and cost of the optical pickup.

In order to solve the above-described problems, JP 2827186 B (title of invention: Method for Detecting Warp of Optical Disk and Optical Pickup) detects the relative tilt of the optical disk to the optical pickup in the following manner. That is, light from a semiconductor laser is branched into three light beams consisting of a main beam and two right and left sub-beams. Then, these three light beams are irradiated onto a signal surface of an optical disk such that light spots of these beams are aligned on a radial line extending from the center of the optical disk. The returning light beams that have been reflected by the optical disk are led to an optical component that generates astigmatism. Out of the three light beams that have passed through this optical component, the two right and left sub-beams are received respectively by two four-divided optical sensors for tilt detection. Positive or negative defocusing of the two sub-beams on the disk signal surface, which is caused by the relative tilt of the optical disk to the optical pickup, is detected from the outputs of the two four-divided optical sensors for tilt detection by an astigmatic method, thereby detecting the relative tilt of the optical disk to the optical pickup. In the configuration described above, the two sub-beams for tilt detection returning from the optical disk have to be led to the center of the two respective four-divided optical sensors. However, when the wavelength of the semiconductor laser changes due to temperature variation, an optical axis of the sub-beam is shifted, so that the returning beam reaches a position shifted from the center of the four-divided optical sensor. As a result, there has been a problem of causing an error in tilt detection signals.

### DISCLOSURE OF INVENTION

In order to solve the problem described above, it is an object of the invention of the present application to provide a tilt detecting device that can detect the relative tilt of an optical information recording medium to an optical axis of an optical head without increasing the size and cost of the optical head and can detect the relative tilt of an optical information recording medium to an optical head in a stable manner without being affected by the variation in laser wavelength caused by temperature variation. It is a further object of the present invention to provide an optical head using this tilt detecting device, and an optical information processing apparatus as well as a computer, a video recording apparatus, a video reproducing apparatus and a car navigation system including this optical information processing apparatus as a storage device.

A tilt detecting device of the present invention includes a light source, a focusing optical system for focusing a light beam from the light source onto an optical information recording medium, an optical branching member for branching a light beam from the light source into a main beam and at least two sub-beams, and a detecting member for detecting a light beam reflected by the optical information recording medium. A focal position of a first focused light beam of the main beam traveling toward the optical information recording medium and focal positions of second focused light beams of the sub-beams traveling toward the optical information recording medium are different in a direction of an optical axis of the focusing optical system and a direction perpendicular thereto, and sizes of spots formed on the detecting member by the sub-beams reflected by the optical information recording medium are detected using the detecting member, thereby detecting a relative tilt of the optical information recording medium with respect to the optical axis of the focusing optical system.

An optical head of the present invention includes the above-described tilt detecting device of the present invention.

An optical information processing apparatus of the present invention has the above-described optical head of the present invention, a driving mechanism for moving the optical information recording medium relative to the optical head, and a control circuit for controlling the optical head and the driving mechanism based on a signal obtained from the optical head.

A computer of the present invention includes the above-described optical information processing apparatus of the present invention.

A video recording apparatus of the present invention includes the above-described optical information processing apparatus of the present invention.

A video reproducing apparatus of the present invention includes the above-described optical information processing apparatus of the present invention.

A car navigation system of the present invention includes the above-described optical information processing apparatus of the present invention.

### BRIEF DESCRIPTION OF DRAWINGS

FIG. 1 shows an exemplary configuration of an optical head of a first embodiment of the present invention.

FIG. 2 is a plan view showing an exemplary arrangement of light-receiving portions of a photo-detector in the optical head of the first embodiment of the present invention.

FIGS. 3A and 3B are drawings for describing a method for detecting a relative tilt of an optical disk to an optical axis of the optical head in the present invention, with FIG. 3A being a plan view showing spots on the light-receiving portions of the photo-detector in a state where the optical axis of the optical head is perpendicular to a surface of the optical disk (where there is no relative tilt) and FIG. 3B being a plan view showing the spots on the light-receiving portions of the photo-detector in a state where the optical axis of the optical head is not perpendicular to the surface of the optical disk (where there is a relative tilt).

FIGS. 4A to 4C show an exemplary structure of a plate optical element (a hologram) for generating a main beam and sub-beams in the optical head in the first embodiment of the present invention, with FIG. 4A being a top view thereof, FIG. 4B being a sectional view taken along a line 4B-4B in FIG. 4A seen from a direction indicated by arrows and FIG. 4B being a bottom view thereof

FIG. 5 shows a schematic configuration of an optical disk drive of a second embodiment of the present invention.

FIG. 6 shows an exemplary configuration of a conventional optical head.

### BEST MODE FOR CARRYING OUT THE INVENTION

According to a tilt detecting device of the present invention, it is possible to detect the relative tilt of an optical information recording medium to an optical axis of an optical head without increasing the size and cost of the optical head and to detect the relative tilt of an optical information recording medium to an optical head in a stable manner without being affected by the variation in laser wavelength caused by temperature variation.

In the above-described tilt detecting device of the present invention, it is preferable to satisfy 0.08>Z/X>0.008, where Z indicates the distance between the focal position of the first focused light beam and the focal positions of the second focused light beams along the direction of the optical axis of the focusing optical system and X indicates the distance therebetween along the direction perpendicular to the optical axis of the focusing optical system. This makes it possible to detect the relative tilt of the optical information recording medium to the optical axis of the optical head in the range from 0.5° to 5°.

Also, in the above-described tilt detecting device of the present invention, it is preferable that light-receiving portions of the detecting member receiving the sub-beams reflected by the optical information recording medium are each divided into three regions by division lines that are substantially parallel with a plane including focal positions of the main beam and the sub-beams that have been reflected by the optical information recording medium. With this configuration, even when the distance between the focal positions of ±1-order light beams and the focal position of a zero-order light beam changes due to temperature variation, a tilt detection signal is not affected.

Further, in the above-described tilt detecting device of the present invention, the optical branching member may be a simple diffraction grating. This makes it possible to obtain the ±1-order light beams (sub-beams) for tilt detection.

Alternatively, in the above-described tilt detecting device of the present invention, the optical branching member may be a plate optical element having a first surface and a second surface facing the first surface. The first surface may be provided with a first hologram pattern with a curvature, the second surface may be provided with a second hologram pattern that is symmetric with the first hologram pattern with respect to an axis parallel with the first surface, and the first and second hologram patterns may have a sawtooth cross-section or a stepwise cross-section. In this way, by changing the pitch and radius of curvature of the hologram patterns, it is possible to change the distance (the distance X and the distance Z mentioned above) between the focal position of the zero-order light beam (main beam) for detecting a reproducing signal and the focal positions of the ±1-order light beams (sub-beams) for detecting a tilt, so that a detectable tilt range can be designed freely.

An optical head of the present invention has the above-described tilt detecting device of the present invention. With this configuration, even when the relative tilt of the optical information recording medium to the optical axis of the optical head is caused due to a warp or the like of the optical information recording medium, a coma aberration can be corrected based on the tilt detection signal, allowing an excellent recording or reproducing operation.

An optical information processing apparatus of the present invention includes the above-described optical head of the present invention, a driving mechanism for moving the optical information recording medium relative to the optical head, and a control circuit for controlling the optical head and the driving mechanism based on a signal obtained from the optical head. With this configuration, even when the relative tilt of the optical information recording medium to the optical axis of the optical head is caused due to a warp or the like of the optical information recording medium, a coma aberration can be corrected based on the tilt detection signal, allowing an excellent recording or reproducing operation.

A computer, a video recording apparatus, a video reproducing apparatus and a car navigation system of the present invention each includes the above-described optical information processing apparatus of the present invention. This makes it possible to provide various apparatus in which, even when the relative tilt of the optical information recording medium to the optical axis of the optical head is caused due to a warp or the like of the optical information recording medium, a coma aberration can be corrected based on the tilt detection signal, allowing an excellent recording or reproducing operation.

The following is a detailed description of the present invention by way of specific embodiments.

(First Embodiment)

An optical head of the first embodiment of the present invention will be described, with reference to the accompanying drawings.

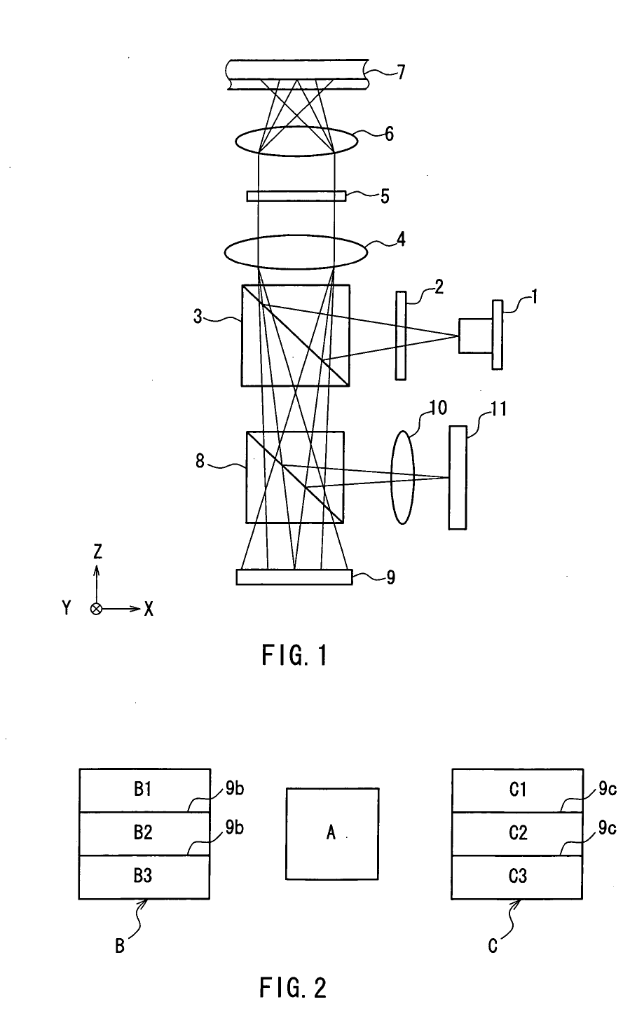

FIG. 1 shows a configuration of the optical head of the first embodiment of the present invention. Numeral 1 denotes a semiconductor laser serving as a light source, numeral 2 denotes a grating serving as an optical branching member (also referred to as a simple diffraction grating), numeral 3 denotes a polarization beam splitter, numeral 4 denotes a collimator lens, numeral 5 denotes a λ/4 wave plate, numeral 6 denotes an objective lens, numeral 7 denotes an optical disk, numeral 8 denotes a half mirror, numerals 9 and 11 denote photo-detectors serving as a detecting member, and numeral 10 denotes a cylindrical lens.

In the following, the operation of the optical head of the first embodiment of the present invention will be described referring to FIG. 1. A linearly polarized light beam emitted from the semiconductor laser 1 is branched into a zero-order light beam transmitted by the grating 2 and ±1-order light beams diffracted by the same. The zero-order light beam and the ±1-order light beams are reflected by the polarization beam splitter 3, turned into substantially parallel light beams when passing through the collimator lens 4, turned into circularly polarized light beams by the λ/4 wave plate 5, enter the objective lens 6 and then are focused onto the optical disk 7. In this case, as shown in the figure, the zero-order light beam serving as a main beam is designed to come into focus on the information recording surface of the optical disk 7, while the ±1-order light beams serving as sub-beams are designed to come into focus at positions shifted from the information recording surface of the optical disk 7 toward the objective lens 6. When Z indicates the distance between the focal position of the zero-order light beam and the focal positions of the ±1-order light beams along an optical axis of the objective lens 6 and X indicates the distance between them along the direction perpendicular to the optical axis, the design is made to satisfy 0.08>X/Z>0.008 (outgoing path).

The zero-order light beam and the ±1-order light beams that have been reflected by the optical disk 7 travel along the same optical path in the reverse direction. In the λ/4 wave plate 5, they are turned into linearly polarized light beams perpendicular to the polarization direction of the light beams emitted from the semiconductor laser 1, and then transmitted by the polarization beam splitter 3 and branched into transmitted light beams and a reflected light beam by the half mirror 8. The transmitted light beams enter the photo-detector 9. The reflected light beam passes through the cylindrical lens 10 and enters the photo-detector 11. The relative tilt of the optical disk 7 to the optical axis of the optical head (namely, the optical axis of the objective lens 6) is detected using the photo-detector 9, while a servo signal such as a focus error signal is detected using the photo-detector 11 (incoming path).

Referring to FIG. 2, the shape of the photo-detector 9 will be described. A light-receiving portion A of the photo-detector 9 receives the zero-order light beam, and light-receiving portions B and C receive the +1-order light beam and −1-order light beam, respectively. As shown in the figure, the light-receiving portions B and C respectively are divided into three regions B1 to B3 and C1 to C3 by division lines 9b and 9c that are substantially parallel with a plane including the focal positions of the zero-order light beam and the ±1-order light beams in the vicinity of the light-receiving portions of the photo-detector 9. When B1, B2, B3, C1, C2 and C3 indicate detection signals corresponding to light beams incident onto the regions B1, B2, B3, C1, C2 and C3, respectively, a relative tilt detection signal θe of the optical disk to the optical axis of the optical head can be detected by
θe=(B1+B3+C2)−(B2+C1+C3).

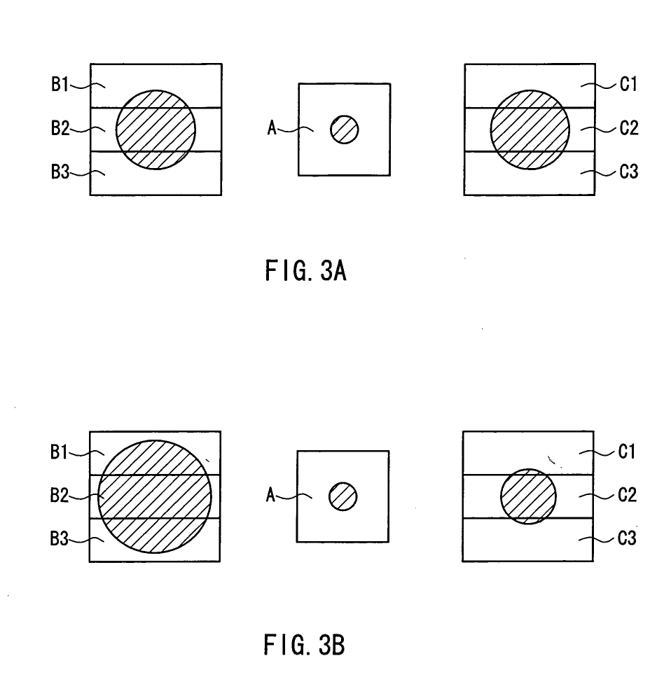

Hereinafter, the principle of detecting the relative tilt of the optical disk to the optical axis of the optical head will be explained referring to FIGS. 3A and 3B. FIG. 3A shows spot shapes on the photo-detector 9 in the state where the optical disk and the optical axis of the optical head are perpendicular to each other. In this case, the tilt detection signal θe=(B1+B3+C2)−(B2+C1+C3)=0. Accordingly, the relative tilt of the optical disk to the optical axis of the optical head is determined to be 0.

FIG. 3B shows the spot shapes on the photo-detector 9 in the state where the optical disk tilts with respect to the optical axis of the optical head. In this case, the tilt detection signal θe=(B1+B3+C2)−(B2+C1+C3)>0. The absolute value of θe increases in keeping with the relative tilt of the optical disk to the optical axis of the optical head. By the method described above, the tilt of the optical disk to the optical axis of the optical head can be detected in the present invention.

Also, by designing X/Z to be in the range of 0.08>X/Z>0.008 as noted above, the range of detectable angles can be set arbitrarily from the state of a small relative tilt to that of a large relative tilt of the optical disk with respect to the optical axis of the optical head, in other words, in an angle ranging from 0.5° to 5°.

Furthermore, in the present invention, as shown in FIGS. 2, 3A and 3B, the division lines dividing the light-receiving portions B and C are made substantially parallel with the plane including the focal positions of the zero-order light beam and the ±1-order light beams in the vicinity of the light-receiving portions, so that the detection signal is not affected even when, owing to the wavelength variation of the laser beam from the semiconductor laser 1 caused by temperature variation, a diffraction angle changes so as to shift the spot positions of the ±1-order light beams.

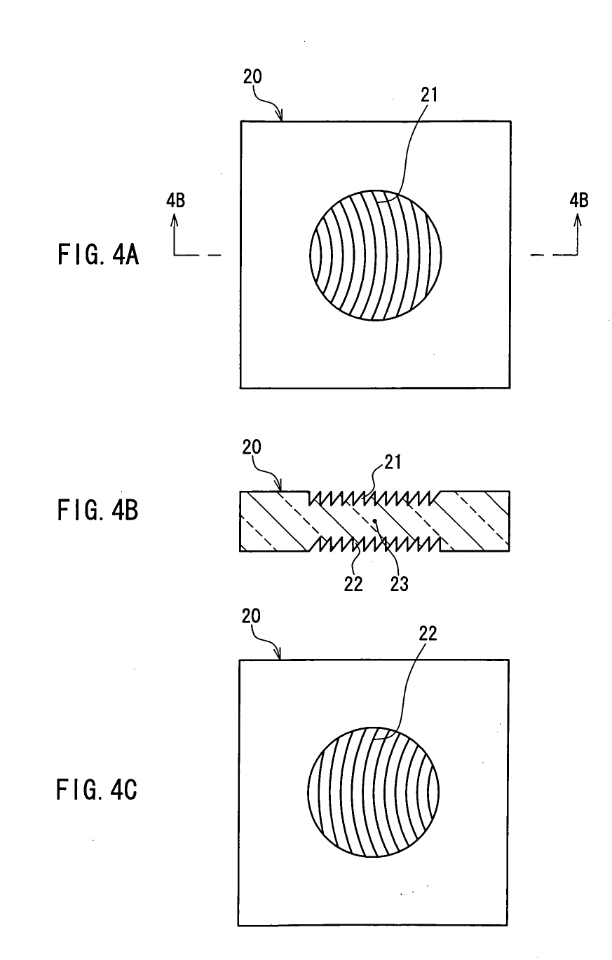

Although the sub-beams for detecting the tilt of the optical disk with respect to the optical axis of the optical head have been generated by the grating 2 in the present embodiment, the present invention is not limited to this. A similar effect can be obtained also by using a plate optical element 20 shown in FIGS. 4A to 4C. FIG. 4A is a top view of the plate optical element 20, FIG. 4B is a sectional view taken along a line 4B-4B in FIG. 4A seen from a direction indicated by arrows, and FIG. 4B is a bottom view of the plate optical element 20. On the top surface and bottom surface of the plate optical element 20, hologram patterns 21 and 22 having a predetermined curvature are formed. The hologram patterns 21 and 22 are symmetric with respect to an axis 23 parallel with the top surface and bottom surface. The hologram patterns 21 and 22 have a sawtooth cross-section or a stepwise cross-section. The above-mentioned distance X can be changed by changing the pitch of the hologram patterns 21 and 22, and the above-mentioned distance Z can be changed by changing the curvature.

(Second Embodiment)

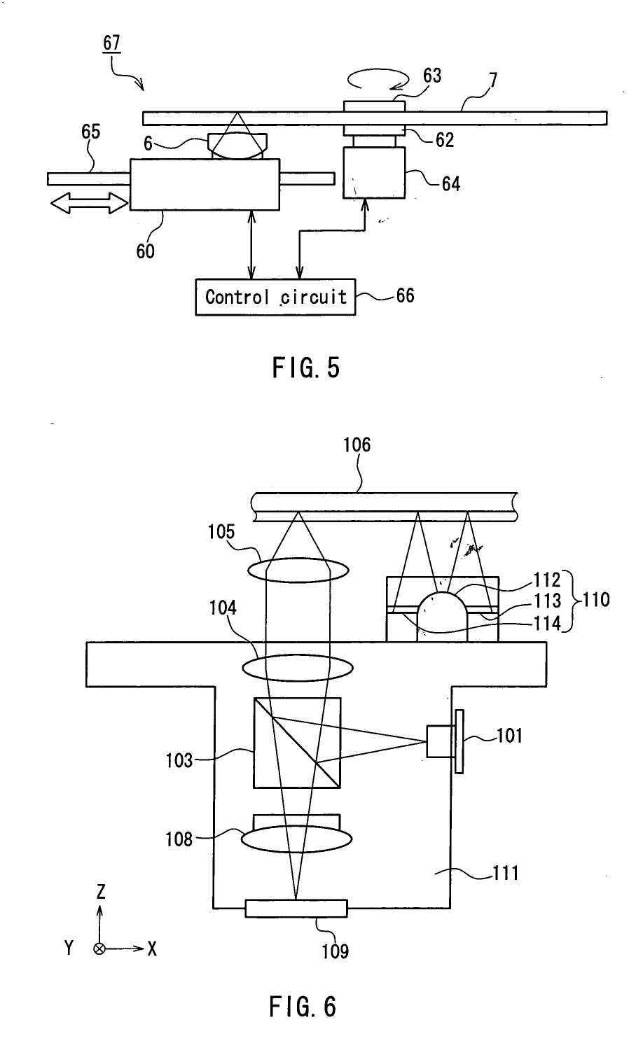

FIG. 5 shows an exemplary configuration of an entire optical disk drive (an optical information processing apparatus) 67 according to the second embodiment of the present invention using an optical head. An optical disk 7 is fixed to a turntable 62 in such a manner as to be sandwiched between the turntable 62 and a damper 63, and is rotated by a motor (a rotating system) 64. An optical head 60 is mounted on a transfer system 65, so that a light beam irradiated from an objective lens 6 of the optical head 60 moves from an inner perimeter to an outer perimeter along a radius of the optical disk 7. Based on a signal received from the optical head 60, a control circuit 66 performs a focusing control and a tracking control of the optical head 60, a traversing control of the carrier system 65 and a rotation control of the motor 64. Further, the control circuit 66 reproduces information recorded on the optical disk 7 based on a reproducing signal from the optical head 60 and records information on the optical disk 7 by sending out a signal to the optical head 60.

The optical head 60 includes the tilt detecting device illustrated in the first embodiment. Based on a relative tilt signal of the optical disk 7 to the optical axis of the optical head 60 detected by the tilt detecting device, a coma aberration of the main beam is corrected by a known means, allowing an excellent recording or reproducing operation.

As a storage device (or an external storage device), for example, the optical disk drive 67 shown in FIG. 5 can be provided internally (or externally) to a computer, a video recording apparatus, a video reproducing apparatus, a car navigation system or the like. In this case, the configuration of the computer, the video recording apparatus, the video reproducing apparatus or the car navigation system other than the storage device is not particularly limited but may be any known configuration.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

1. A tilt detecting device comprising:
a light source;
a focusing optical system for focusing a light beam from the light source onto an optical information recording medium;
an optical branching member for branching a light beam from the light source into a main beam and at least two sub-beams; and
a detecting member for detecting a light beam reflected by the optical information recording medium;
wherein a focal position of a first focused light beam of the main beam traveling toward the optical information recording medium and focal positions of at least two second focused light beams of the sub-beams traveling toward the optical information recording medium are different in a direction of an optical axis of the focusing optical system and a direction perpendicular thereto, whereby sizes of spots formed on the optical information recording medium by the at least two sub-beams change inversely with each other according to a relative tilt of the optical information recording medium with respect to the optical axis of the focusing optical system, and
the at least two sub-beams reflected by the optical information recording medium are detected using the detecting member, thereby detecting the relative tilt of the optical information recording medium with respect to the optical axis of the focusing optical system.

2. The tilt detecting device according to claim 1, satisfying 0.08>Z/X>0.008, where Z indicates the distance between the focal position of the first focused light beam and the focal positions of the second focused light beams along the direction of the optical axis of the focusing optical system and X indicates the distance therebetween along the direction perpendicular to the optical axis of the focusing optical system.

3. The tilt detecting device according to claim 1, wherein light-receiving portions of the detecting member receiving the sub-beams reflected by the optical information recording medium are each divided into three regions by division lines that are substantially parallel with a plane including focal positions of the main beam and the sub-beams that have been reflected by the optical information recording medium.

4. The tilt detecting device according to claim 1, wherein the optical
